(19) United States
(12) Patent Application Publication
(10) Pub. No.: US 2015/0269241 A1
(43) Pub. Date: Sep. 24, 2015

(54) TIME SERIES CLUSTERING

(71) Applicant: SAS Institute Inc., Cary, NC (US)

(72) Inventors: Taiyeong Lee, Cary, NC (US); Shunping Huang, Chapel Hill, NC (US); Ruiwen Zhang, Cary, NC (US); Jared Langford Dean, Cary, NC (US)

(21) Appl. No.: 14/482,726

(22) Filed: Sep. 10, 2014

Related U.S. Application Data
(60) Provisional application No. 61/968,331, filed on Mar. 20, 2014.
(60) Provisional application No. 62/002,185, filed on May 23, 2014.

(51) Int. Cl. G06F 17/30

(52) U.S. Cl. CPC G06F 17/30598

(57) ABSTRACT

A method of transforming time series data to cluster data is provided. Time series data including a plurality of time series is received. A distance between a first time series of the plurality of time series and each of a remaining set of time series of the plurality of time series is computed pairwise between each of the remaining set of time series of the plurality of time series and the first time series. The computed values of the distance are sorted in increasing value. Gap width values are computed as a difference between successive pairs of the sorted, computed values. Whether a cluster including the received time series data is uniform is determined based on the computed gap width values. Cluster data including the first time series and the remaining set of time series assigned to the cluster is output when the cluster is determined to be uniform.

### CROSS-REFERENCE TO RELATED APPLICATIONS

The present application claims the benefit of 35 U.S.C. §119(e) to U.S. Provisional Patent Application No. 61/968,331 filed on Mar. 20, 2014, and to U.S. Provisional Patent Application No. 62/002,185 filed on May 23, 2014, the entire contents of which are hereby incorporated by reference.

### BACKGROUND

Time series, or sequence, clustering may be used to support time series data mining by grouping time series that have a similar pattern into a cluster. Example time series include stock market prices, interest rates, sales of a product, scientific results, weather readings, sensor readings, medical records, manufacturing processes, etc. Time series clustering may be based on a distance measurement calculated between time points in pairs of time series and used to identify temporal patterns in the data.

### SUMMARY

In an example embodiment, a method of transforming time series data to cluster data is provided. Time series data is received. The time series data includes a plurality of time series. A plurality of time points are defined in association with each of the plurality of time series. Values of a distance between a first time series of the plurality of time series and each of a remaining set of time series of the plurality of time series is computed. The values of the distance are computed pairwise between each of the remaining set of time series of the plurality of time series and the first time series. The computed values of the distance are sorted in increasing value. Gap width values are computed as a difference between successive pairs of the sorted, computed values. Whether a cluster including the received time series data is uniform is determined based on the computed gap width values. Cluster data that includes the first time series and the remaining set of time series assigned to the cluster is output when the cluster is determined to be uniform.

In another example embodiment, a computer-readable medium is provided having stored thereon computer-readable instructions that, when executed by a computing device, cause the computing device to perform the method of transforming time series data to cluster data.

In yet another example embodiment, a computing device is provided. The system includes, but is not limited to, a processor and a computer-readable medium operably coupled to the processor. The computer-readable medium has instructions stored thereon that, when executed by the computing device, cause the computing device to perform the method of transforming time series data to cluster data.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of a data transformation device in accordance with an illustrative embodiment.

FIGS. 2a and 2b depict a flow diagram illustrating examples of operations performed by the data transformation device of FIG. 1 in accordance with an illustrative embodiment.

FIG. 3 depicts times series divided into clusters in accordance with an illustrative embodiment.

FIG. 4 depicts gap width values between time series in accordance with an illustrative embodiment.

### DETAILED DESCRIPTION

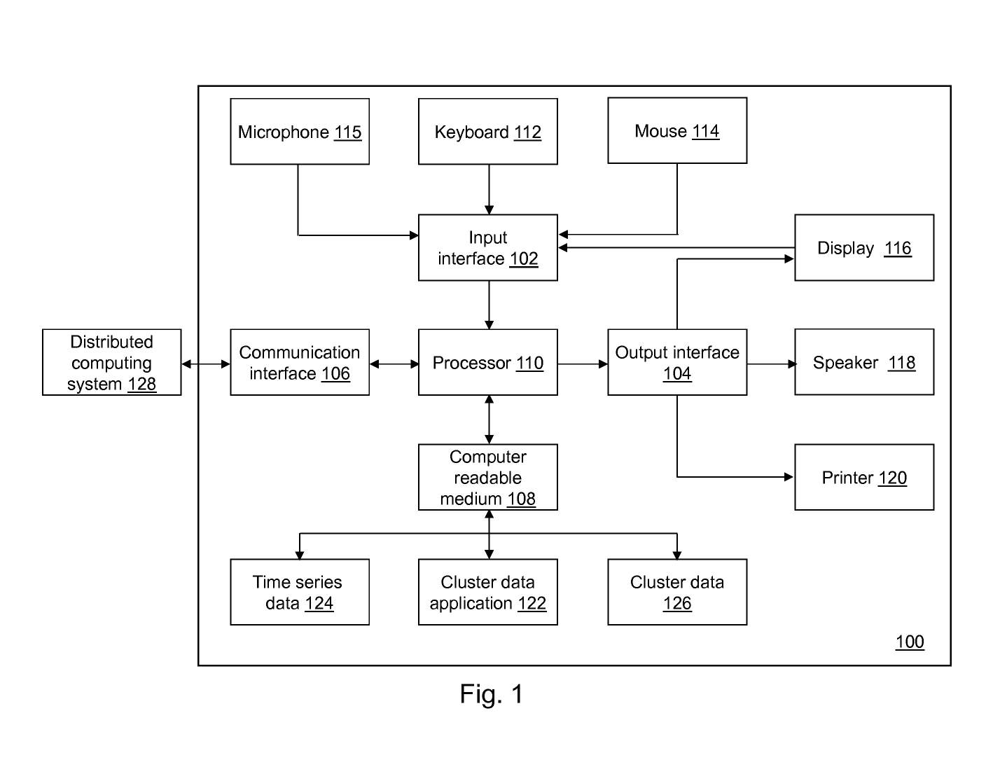

Referring to FIG. 1, a block diagram of a data transformation device 100 is shown in accordance with an illustrative embodiment. Data transformation device 100 may include an input interface 102, an output interface 104, a communication interface 106, a computer-readable medium 108, a processor 110, a cluster data application 122, time series data 124, and cluster data 126. Fewer, different, and/or additional components may be incorporated into data transformation device 100.

Input interface 102 provides an interface for receiving information from the user for entry into data transformation device 100 as understood by those skilled in the art. Input interface 102 may interface with various input technologies including, but not limited to, a keyboard 112, a mouse 114, a microphone 115, a display 116, a track ball, a keypad, one or more buttons, etc. to allow the user to enter information into data transformation device 100 or to make selections presented in a user interface displayed on the display. The same interface may support both input interface 102 and output interface 104. For example, display 116 comprising a touch screen provides user input and presents output to the user. Data transformation device 100 may have one or more input interfaces that use the same or a different input interface technology. The input interface technology further may be accessible by data transformation device 100 through communication interface 106.

Output interface 104 provides an interface for outputting information for review by a user of data transformation device 100 and/or for use by another application. For example, output interface 104 may interface with various output technologies including, but not limited to, display 116, a speaker 118, a printer 120, etc. Data transformation device 100 may have one or more output interfaces that use the same or a different output interface technology. The output interface technology further may be accessible by data transformation device 100 through communication interface 106.

Communication interface 106 provides an interface for receiving and transmitting data between devices using various protocols, transmission technologies, and media as understood by those skilled in the art. Communication interface 106 may support communication using various transmission media that may be wired and/or wireless. Data transformation device 100 may have one or more communication interfaces that use the same or a different communication interface technology. For example, data transformation device 100 may support communication using an Ethernet port, a Bluetooth antenna, a telephone jack, a USB port, etc. Data and messages may be transferred between data transformation device 100 and/or a grid control device 130 and/or grid systems 132 using communication interface 106.

Computer-readable medium 108 is an electronic holding place or storage for information so the information can be accessed by processor 110 as understood by those skilled in the art. Computer-readable medium 108 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. Data transformation device 100 may have one or more computer-readable media that use the same or a different memory media technology. For example, computer-readable medium 108 may include different types of computer-readable media that may be organized hierarchically to provide efficient access to the data stored therein as understood by a person of skill in the art. As an example, a cache may be implemented in a smaller, faster memory that stores copies of data from the most frequently/recently accessed main memory locations to reduce an access latency. Data transformation device 100 also may have one or more drives that support the loading of a memory media such as a CD, DVD, an external hard drive, etc. One or more external hard drives further may be connected to data transformation device 100 using communication interface 106.

Processor 110 executes instructions as understood by those skilled in the art. The instructions may be carried out by a special purpose computer, logic circuits, or hardware circuits. Processor 110 may be implemented in hardware and/or firmware. Processor 110 executes an instruction, meaning it performs/controls the operations called for by that instruction. The term “execution” is the process of running an application or the carrying out of the operation called for by an instruction. The instructions may be written using one or more programming language, scripting language, assembly language, etc. Processor 110 operably couples with input interface 102, with output interface 104, with communication interface 106, and with computer-readable medium 108 to receive, to send, and to process information. Processor 110 may retrieve a set of instructions from a permanent memory device and copy the instructions in an executable form to a temporary memory device that is generally some form of RAM. Data transformation device 100 may include a plurality of processors that use the same or a different processing technology.

Cluster data application 122 performs operations associated with creating cluster data 126 from data stored in time series data 124. The created cluster data 126 may be used to perform various data mining functions and to support various data analysis functions as understood by a person of skill in the art. Some or all of the operations described herein may be embodied in cluster data application 122. The operations may be implemented using hardware, firmware, software, or any combination of these methods. Referring to the example embodiment of FIG. 1, cluster data application 122 is implemented in software (comprised of computer-readable and/or computer-executable instructions) stored in computer-readable medium 108 and accessible by processor 110 for execution of the instructions that embody the operations of cluster data application 122. Cluster data application 122 may be written using one or more programming languages, assembly languages, scripting languages, etc.

Cluster data application 122 may be implemented as a Web application. For example, cluster data application 122 may be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

Time series data 124 includes a plurality of time series, with each time series including a plurality of time points. The data stored in time series data 124 may include any type of content represented in any computer-readable format such as binary, alphanumeric, numeric, string, markup language, etc. The content may include textual information, graphical information, image information, audio information, numeric information, etc. that further may be encoded using various encoding techniques as understood by a person of skill in the art. Time series data 124 may be stored in computer-readable medium 108 or on computer-readable media on or accessible by one or more other computing devices, such as distributed computing system 128, and accessed using communication interface 106. Time series data 124 may be stored using various formats as known to those skilled in the art including a file system, a relational database, a system of tables, a structured query language database, etc. For example, time series data 124 may be stored in a cube distributed across a grid of computers as understood by a person of skill in the art. As another example, time series data 124 may be stored in a multi-node Hadoop® cluster, as understood by a person of skill in the art.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and. Some systems may use SAS In-Memory Statistics for Hadoop® to read big data once and analyze it several times by persisting it in-memory for the entire session. Some systems may be of other types and configurations.

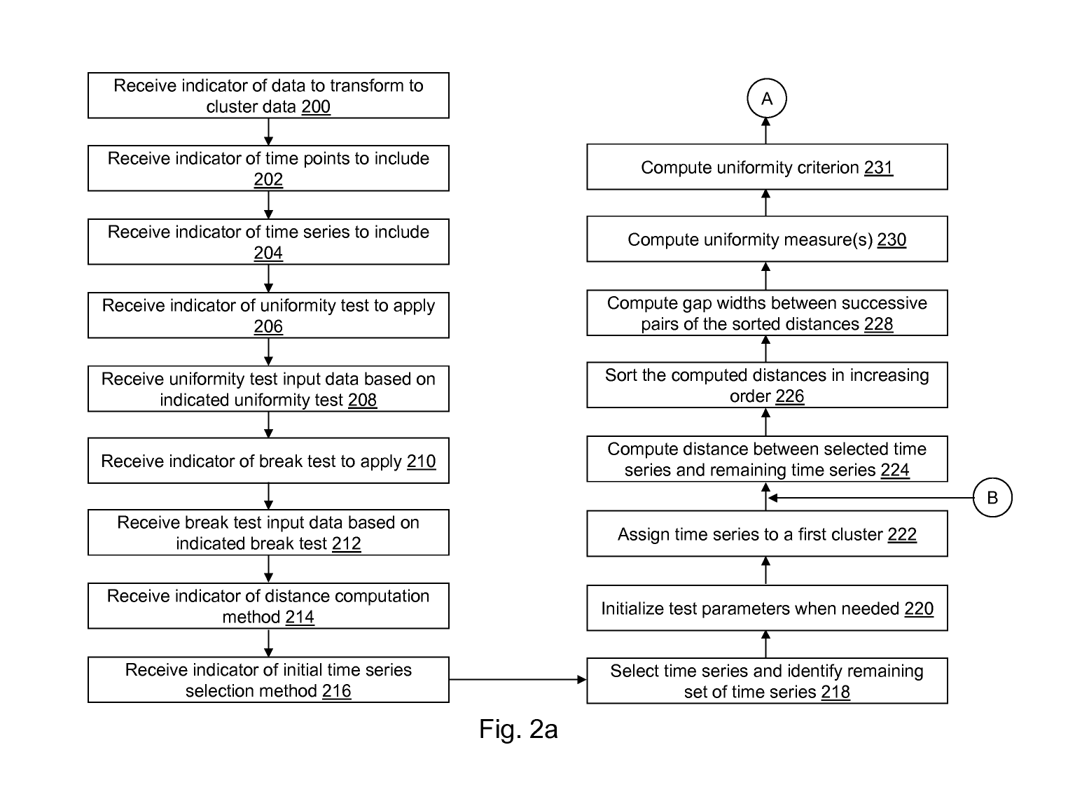

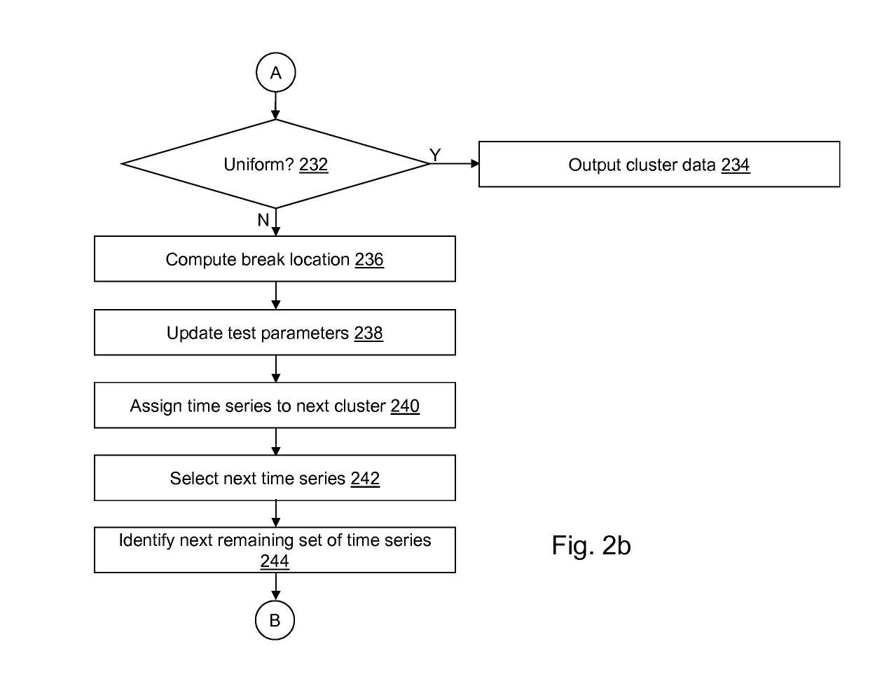

Referring to FIGS. 2a-2b, example operations associated with cluster data application 122 are described. For example, cluster data application 122 may be used to create cluster data 126 from time series data 124. For example, referring to FIG. 3, ten times series, TS₁, TS₂, TS₃, . . . , TS₁₀ are shown divided into a first cluster 300, a second cluster 302, and a third cluster 304, where first cluster 300 includes TS₁, TS₆, TS₈, second cluster 302 includes TS₂, TS₃, TS₇, TS₉, and third cluster 304 includes TS₄, TS₅, TS₁₀. Cluster data 126 is a transformation of time series data 124 that may be used in support of various data mining and data analysis tasks. Additional, fewer, or different operations may be performed depending on the embodiment. The order of presentation of the operations of FIGS. 2a-2b is not intended to be limiting. Although some of the operational flows are presented in sequence, the various operations may be performed in various repetitions, concurrently (in parallel, for example, using threads), and/or in other orders than those that are illustrated. For example, a user may execute cluster data application 122, which causes presentation of a first user interface window, which may include a plurality of menus and selectors such as drop down menus, buttons, text boxes, hyperlinks, etc. associated with cluster data application 122 as understood by a person of skill in the art. The plurality of menus and selectors may be accessed in various orders. An indicator may indicate one or more user selections from a user interface, one or more data entries into a data field of the user interface, one or more data items read from computer-readable medium 108 or otherwise defined with one or more default values, etc. that are received as an input by cluster data application 122.

Referring to FIG. 2a, in an operation 200, a first indicator is received that indicates data to transform to cluster data 126. For example, the first indicator indicates a location of time series data 124. As an example, the first indicator may be received by cluster data application 122 after selection from a user interface window or after entry by a user into a user interface window. In an alternative embodiment, the data to transform may not be selectable. For example, a most recently created data set may be used automatically.

In an operation 202, a second indicator is received that indicates time points in time series data 124 to include in cluster data 126. The second indicator may indicate that only a subset of the time points included in each time series stored in time series data 124 be included in cluster data 126. The second indicator further may indicate a number of time points to include in cluster data 126, a percentage of time points of time series data 124 to include in cluster data 126, etc. A subset of the time points may be created from time series data 124 by sampling. An example sampling algorithm is uniform sampling. Other random sampling algorithms may be used. In an alternative embodiment, the second indicator may not be received. For example, all of the time points may be used automatically. The time points within a time series may be captured at regular or irregular time intervals. Additionally, the time points of different time series may be captured at the same or at different times.

In an operation 204, a third indicator is received that indicates one or more time series in time series data 124 to include in cluster data 126. The third indicator may indicate that only a subset of the time series included in time series data 124 be included in cluster data 126. The third indicator further may indicate a number of time series to include in cluster data 126, a percentage of time series of time series data 124 to include in cluster data 126, a list of specific time series to include in cluster data 126, etc. A subset of the time series may be created from time series data 124 by sampling. An example sampling algorithm is uniform sampling. Other random sampling algorithms may be used. In an alternative embodiment, the third indicator may not be received. For example, all of the time series may be used automatically. The collection of time series may be denoted as {TS_{c1}, TS_{c2}, TS_{c3}, . . . , TS_{cn}} with the length of each time series denoted as T, where c1, c2, . . . , cn may indicate a column number in time series data 124.

In an operation 206, a fourth indicator of a uniformity test to apply is received. For example, the fourth indicator indicates a name of a uniformity test. The fourth indicator may be received by cluster data application 122 after selection from a user interface window or after entry by a user into a user interface window. A default value for the uniformity test may further be stored, for example, in computer-readable medium 108. As an example, a uniformity test may be selected from a “maximum test”, a “minimum test”, a “mean test”, a “median test”, a “hypothesis test”, etc. Of course, the uniformity test may be labeled or selected in a variety of different manners by the user as understood by a person of skill in the art. In an alternative embodiment, the uniformity test may not be selectable, and a single uniformity test is implemented in cluster data application 122.

In an operation 208, uniformity test input data, if any, is received based on the indicated uniformity test or the defined default uniformity test. For example, any or all of a confidence interval, a distribution indicator, a confidence parameter value, a significance level, an initial significance level, a discount factor, a test statistic indicator, a first number of candidates, etc. may be received for the indicated uniformity test.

As an example, when the indicated uniformity test is “maximum test”, “minimum test”, “mean test”, “median test”, the confidence interval may be defined that is a percentage value between 0 and 100, non-inclusive; the distribution indicator may be defined that is selected from a type of statistical distribution, such as a standard normal distribution; the confidence parameter value, c, may be defined based on a combination of the confidence interval and the type of statistical distribution; and/or the first number of candidates may define a subset of time series candidates to evaluate in determining the maximum, minimum, mean, and/or median statistic of the indicated uniformity test. For illustration, when the confidence parameter value is defined, the confidence interval and the distribution indicator need not be defined because the confidence interval and the distribution indicator are used to compute the confidence parameter value. For example, a confidence parameter value equal to 1.96 may be input by a user and received in operation 208, or a confidence interval equal to 95% and a distribution indicator indicating standard normal distribution may be input by a user and received in operation 208.

The first number of candidates, m₁, may be defined to indicate that all of the remaining time series candidates are used to evaluate the maximum, minimum, mean, and/or median statistic of the indicated uniformity test. For example, when the indicated uniformity test is “hypothesis test”, the significance level may be defined as understood by a person of skill in the art; the initial significance level may be defined; the discount factor may be defined that indicates a factor by which the initial significance level is reduced each iteration (described more fully later); and/or the test statistic indicator may be defined that is selected from a type of test statistic computation method as understood by a person of skill in the art. An example type of test statistic computation method is “Cressie Statistic”, for example, as described in N. Cressie, Power results for tests based on high-order gaps, Biometrika, 65(1), 214-218 (1978). A test statistic provides a measure of an attribute of a dataset used in statistical hypothesis testing. The test statistic computation method defines the mathematical function used to compute the test statistic. Other test statistic computation methods include a “Greenwood statistic”, a “Moran statistic”, a “Quesenberry and Miller statistic”, a “Cressie-Read statistic”, etc. Illustrative test statistic computation methods are described in Marhuenda Garcia et al., A comparison of uniformity tests, Statistics: A Journal of Theoretical and Applied Statistics, 39 (4), 315-328 (2005).

In an alternative embodiment, the test statistic computation method may not be selectable, and a single test statistic computation method is implemented in cluster data application 122. When the significance level is defined, the initial significance level and the discount factor need not be defined because the initial significance level and the discount factor are used to compute the significance level each iteration of the uniformity test as discussed further below.

In an operation 210, a fifth indicator of a break test to apply is received. The break test determines where to split the one or more time series into separate clusters as discussed further below. For example, the fifth indicator indicates a name of a break test. The fifth indicator may be received by cluster data application 122 after selection from a user interface window or after entry by a user into a user interface window. A default value for the break test may further be stored, for example, in computer-readable medium 108. As an example, a break test may be selected from a “maximum test”, a “minimum test”, a “mean test”, a “median test”, a “sequential local uniformity test”, etc. Of course, the break test may be labeled or selected in a variety of different manners by the user as understood by a person of skill in the art. In an alternative embodiment, the break test may not be selectable, and a single break test is implemented in cluster data application 122.

In an operation 212, break test input data, if any, is received based on the indicated break test or the defined default break test. For example, a second number of candidates, m₂, may be received for the indicated break test. The second number of candidates may be the same or different from the first number of candidates. In an alternative embodiment, only one of the first number of candidates and the second number of candidates may be received as an input by cluster data application 122.

In an operation 214, a sixth indicator of a distance computation method is received. For example, the sixth indicator indicates a name of a distance computation method. The sixth indicator may be received by cluster data application 122 after selection from a user interface window or after entry by a user into a user interface window. A default value for the distance computation method may further be stored, for example, in computer-readable medium 108. As an example, a distance computation method may be selected from “Euclidian distance”, “Dynamic Time Warping distance”, “Hamming distance”, “Manhattan distance”, etc. For illustration, the Euclidian and Dynamic Time Warping distance calculations are described in E. Keogh & M. Pazzani, Scaling Up Dynamic Time Warping for Datamining Applications, Proceedings of the Sixth ACM SIGKDD International Conference on Knowledge Discovery and Data Mining, 285-289 (2000). As an example, a default distance computation method may be the dynamic time warping distance computation method. Of course, the distance computation method may be labeled or selected in a variety of different manners by the user as understood by a person of skill in the art. In an alternative embodiment, the distance computation method may not be selectable, and a single distance computation method is implemented in cluster data application 122.

In an operation 216, a seventh indicator of an initial time series selection method is received. For example, the seventh indicator indicates a name of an initial time series selection method. The seventh indicator may be received by cluster data application 122 after selection from a user interface window or after entry by a user into a user interface window. A default value for the initial time series selection method may further be stored, for example, in computer-readable medium 108. As an example, an initial time series selection method may be selected from “user input”, “random”, “first time series”, “last time series”, etc. Of course, the initial time series selection method may be labeled or selected in a variety of different manners by the user as understood by a person of skill in the art. In an alternative embodiment, the initial time series selection method may not be selectable, and a single initial time series selection method is implemented in cluster data application 122.

In an operation 218, a time series is selected using the initial time series selection method, and the remaining set of time series are identified. For example, if the “user input” selection method is indicated, a user input time series number is received and is used to select the time series. If the “random” selection method is indicated, a random number is drawn between one and the number of time series selected for inclusion in operation 204. The drawn random number is used to select the time series. If the “first time series” selection method is indicated, the first time series of the time series selected for inclusion in operation 204 is used as the time series. If the “last time series” selection method is indicated, the last time series of the time series selected for inclusion in operation 204 is used as the time series. The remaining set of time series are identified as the time series selected for inclusion in operation 204 excluding the selected time series.

In an operation 220, test parameters are initialized when needed. For example, when the confidence interval and the distribution indicator are defined, the confidence parameter value is defined based on the confidence interval and the distribution indicator. As another example, the significance level may be initialized with the initial significance level when the initial significance level is defined. As another example, an iteration number, I, may be initialized to one.

In an operation 222, each time series selected for inclusion in operation 204 is assigned to a first cluster. For example, an index to each time series may be saved in association with the iteration number to assign the time series to the first cluster.

In an operation 224, a distance is computed between the selected time series, TSₖ, where k defines an index to the selected time series, and each of the time series in the remaining set of time series, TSⱼ, jε{1, 2, . . . , nᵣ}, where nᵣ is a number of time series in the remaining set of time series other than TSₖ. For example, a distance D(k,j) is a distance computed between time series TSₖ and each of the TSⱼ and can be denoted as D(k,j)=Distance (TSₖ, TSⱼ) for jε{1, 2, . . . , nᵣ}. A time series index associated with the selected time series and a remaining time series index associated with each of the time series in the remaining set of time series may be stored in an array, list, etc. so that the time series pairs may be identified that resulted in the computed distance. For example, the remaining time series index array may be {TS_{I1}, TS_{I2}, TS_{I3}, . . . , TS_{In}_{ᵣ}}, where each entry is an integer index that identifies a column in time series data 124 from which the respective time series was read. The distance is computed using the distance computation method indicated by the seventh indicator in operation 214 or defined by default.

In an operation 226, the computed distances, D(k,j), are sorted in increasing order. For example, the i^{th} order statistic of D(k,j) is defined as Dₖ₍ᵢ₎, i=1, . . . nᵣ.

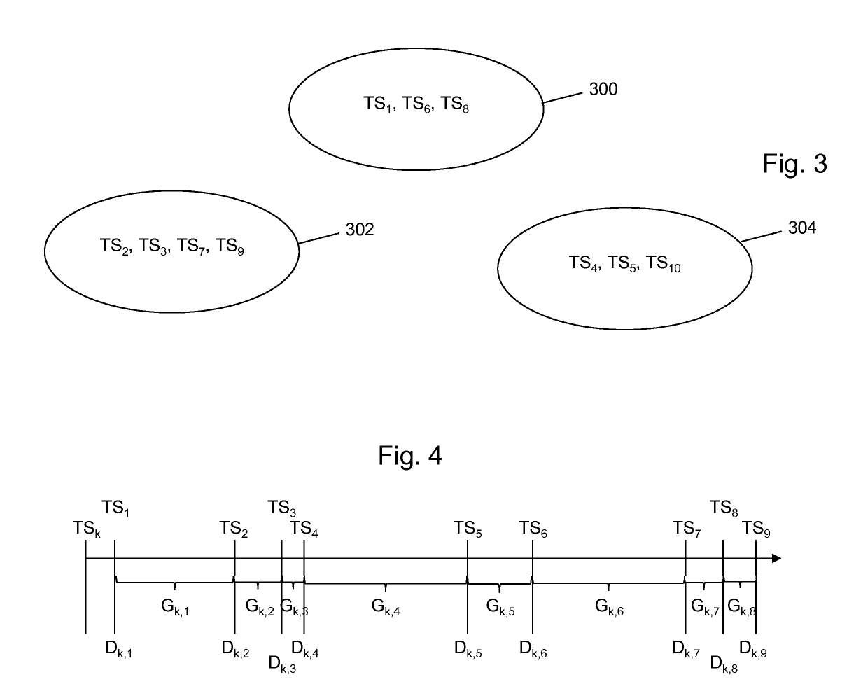

In an operation 228, a gap width, G_{k,i}, is computed between successive pairs of the sorted distances. For example, G_{k,i-1}=Dₖ₍ᵢ₋₁₎−Dₖ₍ᵢ₋₁₎, i=2, . . . , nᵣ. For example, referring to FIG. 4, Dₖ₍ᵢ₎, i=1, . . . 9 for nine remaining series, TSⱼ, jε{1, 2, . . . , 9}, are shown relative to TSₖ and sorted in increasing order from TSₖ. The gap widths, G_{k,i}, i=1, . . . 9 are shown between successive pairs of the sorted distances. The remaining time series index array may be {3, 7, 9, . . . , 8} to associate each time series TSⱼ back to a column in time series data 124, and TSₖ may be the time series stored in column 2 of time series data 124.

In an operation 230, a uniformity measure U_{Gk} is computed. For example, when the indicated uniformity test is “maximum test”, “minimum test”, “mean test”, or “median test”, an upper end of a confidence interval may be computed as the uniformity measure based on a mean, G̅ₖ, and a standard deviation, se(Gₖ), computed for the gap width values G_{k,i} computed in operation 228. The uniformity measure may be computed using U_{Gk}= G̅ₖ c*se(Gₖ), where c is the confidence parameter value, for example, defined in operation 208.

As another example, when the indicated uniformity test is “hypothesis test”, the uniformity measure may be computed using the test statistic computation indicated in operation 208. For example, when the type of test statistic computation is “Cressie”, the gap width values G_{k,i} may be normalized into the range of [0,1]. As understood by a person of skill in the art, an example normalization equation may be

$${u}_{i} = \frac{{G}_{k , i} - min \{ {G}_{k} \}}{max \{ {G}_{k} \} - min \{ {G}_{k} \}}$$

for (i=1, . . . , nᵣ) though there are many others. The test statistic value may be computed using Lₙ_{ᵣ}^{(m}^{₁}⁾=Σᵢ₌₀ⁿ^{ᵣ}^{-m}^{₁}⁺¹ log(u₍ᵢ₊ₘ_{₁}₎−u₍ᵢ₎), where u₍ᵢ₎ is the i^{th} order statistic of u₁, . . . , uₙ_{ᵣ}, u₍₀₎=0, u₍ₙ_{ᵣ}₊₁₎=1, and m₁ is the first number of candidates defined in operation 208. U_{Gk} may be computed as a p-value of the test statistic value. As understood by a person of skill in the art, the p-value is a probability of obtaining a test statistic result at least as extreme as the test statistic value calculated, assuming that a null hypothesis is true. For example, the null hypothesis H₀: f(x)=1 (0≦x≦1), which may be tested against H₁: f=f₁, a general alternative using a formula associated with the defined type of test statistic computation.

In an operation 231, a uniformity criterion CUₖ is computed. For example, when the indicated uniformity test is “maximum test”, “minimum test”, “mean test”, or “median test”, the gap width values G_{k,i} may be sorted in increasing order to define an i^{th} order statistic of G_{k,i} as Gₖ₍ᵢ₎, i=1, 2, . . . , nᵣ−1. For example, referring again to FIG. 4, the gap width values, G_{k,i}, may be sorted in increasing order as G_{k,3}, G_{k,8}, G_{k,7}, G_{k,2}, G_{k,5}, G_{k,1}, G_{k,6}, G_{k,4}, and Gₖ₍ᵢ₎, i=1, 2, . . . , nᵣ−1 is the gap width associated with each gap width value in that order. Alternatively, the gap width values, G_{k,i}, may sorted in decreasing order. When the indicated uniformity test is “maximum test”, the uniformity criterion may be computed as CUₖ=Maximum of {Gₖ₍ₙ_{ᵣ}₋₁₎ Gₖ₍ₙ_{ᵣ}₋₂₎, . . . , Gₖ₍ₙ_{ᵣ}₋ₘ_{₁}₎}. When the indicated uniformity test is “minimum test”, the uniformity criterion may be computed as CUₖ=Minimum of {Gₖ₍ₙ_{ᵣ}₋₁₎ Gₖ₍ₙ_{ᵣ}₋₂₎, . . . , Gₖ₍ₙ_{ᵣ}₋ₘ_{₁}₎}. When the indicated uniformity test is “mean test”, the uniformity criterion may be computed as CUₖ=Mean of {Gₖ₍ₙ_{ᵣ}₋₁₎ Gₖ₍ₙ_{ᵣ}₋₂₎, . . . , Gₖ₍ₙ_{ᵣ}₋ₘ_{₁}₎}. When the indicated uniformity test is “median test”, the uniformity criterion may be computed as CUₖ=Median of {Gₖ₍ₙ_{ᵣ}₋₁₎ Gₖ₍ₙ_{ᵣ}₋₂₎, . . . , Gₖ₍ₙ_{ᵣ}₋ₘ_{₁}₎}.

As another example, when the indicated uniformity test is “hypothesis test”, the uniformity criterion may be the value of the significance level defined in operation 208 and/or initialized in operation 220.

Referring to FIG. 2b, in an operation 232, a determination is made concerning whether or not the selected time series and the remaining set of time series are uniform based on application of the uniformity test. The uniformity test is based on the distribution of gap width values G_{k,i}. For example, when U_{Gk}≧CUₖ, the selected time series and the remaining set of time series may be determined to be uniform, and no further clustering is performed. When the selected time series and the remaining time series are uniform, processing continues in an operation 234. When the selected time series and the remaining time series are not uniform, processing continues in an operation 236 to define a next cluster.

In operation 234, cluster data 126 is output and clustering of time series data 124 is complete. Cluster data 126 may include the number of clusters and data defining which time series are included in each cluster. For example, the index for each time series may be output in association with the iteration number. When the selected time series and the remaining time series are uniform on a first iteration, all of the time series are included in a single cluster. Cluster data 126 may be stored on one or more devices and/or on computer-readable medium 108 in a variety of formats as understood by a person of skill in the art. Cluster data 126 further may be output to display 116, to printer 120, etc.

In operation 236, a break location CBₖ is computed. For example, when the indicated break test is “maximum test”, “minimum test”, “mean test”, “median test”, the gap width values, G_{k,i}, may be sorted in increasing order to define the i^{th} order statistic of G_{k,i} as Gₖ₍ᵢ₎, i=1, 2, . . . , nᵣ−1, if not already computed. Alternatively, the gap width values, G_{k,i}, may sorted in decreasing order. When the indicated break test is “maximum test”, the break location may be computed as CBₖ=Maximum of {Gₖ₍ₙ_{ᵣ}₋₁₎ Gₖ₍ₙ_{ᵣ}₋₂₎, . . . , Gₖ₍ₙ_{ᵣ}₋ₘ_{₂}₎}, where m₂ is the second number of candidates defined in operation 212. For example, referring again to FIG. 4, when the indicated break test is “maximum test”, the gap width value, G_{k,i}, associated with G_{k,4} is a maximum gap width value so the break location occurs between TS₄ and TS₅. When the indicated break test is “minimum test”, the break location may be computed as CBₖ=Minimum of {Gₖ₍ₙ_{ᵣ}₋₁₎ Gₖ₍ₙ_{ᵣ}₋₂₎, . . . , Gₖ₍ₙ_{ᵣ}₋ₘ_{₂}₎}. When the indicated break test is “mean test”, the break location may be computed as CBₖ=Mean of {Gₖ₍ₙ_{ᵣ}₋₁₎ Gₖ₍ₙ_{ᵣ}₋₂₎, . . . , Gₖ₍ₙ_{ᵣ}₋ₘ_{₂}₎}. When the indicated break test is “median test”, the break location may be computed as CBₖ=Median of {Gₖ₍ₙ_{ᵣ}₋₁₎ Gₖ₍ₙ_{ᵣ}₋₂₎, . . . , Gₖ₍ₙ_{ᵣ}₋ₘ_{₂}₎}. The uniformity test and the break test may be the same or different. Of course, when the uniformity test and the break test are the same, CBₖ=CUₖ.

Another break test could be the sequential local uniformity test. Using the sequential local uniformity test, the natural break point is chosen at each iteration as follows. An i^{th} order statistic of G_{k,i} is defined as Gₖ₍ᵢ₎, i=1, 2, . . . , n−2. The second number of candidates, m₂, largest gaps {Gₖ₍ₙ₋₂₎ Gₖ₍ₙ₋₃₎, . . . , Gₖ₍ₙ₋ₘ₋₁₎} are selected from Gₖ₍ᵢ₎ keeping the original order of i as {G_{k(n-2),i}_{₁}, G_{k(n-3),i}_{₂}, . . . , G_{k(n-m-1),i}_{ₘ}}. The subscripts i₁, . . . , iₘ are the corresponding subscripts i from Gₖ={G_{k,i}, i=2, . . . , n−1}. Redefine G_{k(n-m-1),i}_{ₘ}=G_{k,i}_{ₘ}. The local uniformity test is conducted with the set of gaps G_{k,i} from i=2 to i=i₁. The “local” means a subset of gaps is used for the uniformity test, but follows the same test procedure explained above. If the local uniformity null hypothesis is rejected, the natural break point CBₖ=G_{k,i}_{₁} indicates the criterion of natural breaks as CBₖ. If the null hypothesis is not rejected, the next local uniformity test is determined with a new subset of gaps G_{k,i} from i=2 to i=i₂. If the null hypothesis is rejected, the natural break point CBₖ=G_{k,i}_{₂} and so on.

In an operation 238, test parameters are updated. For example, an iteration number, I, may be incremented. As another example, when the indicated uniformity test is “hypothesis test”, the significance level may be updated using

$${α}_{i} = {{α}_{0} ( \frac{1}{d} )}^{I - 1} ,$$

where α₀ is the initial significance level, d is the discount factor, I is the iteration number, and αᵢ is the updated significance level. Adjusting the significance level prevents the generation of numerous small clusters at the end of the iterations.

In an operation 240, the remaining set of time series excluding each time series associated with TS₍ᵢ₎: G_{k,i}<CBₖ, i=1, . . . , nᵣ are assigned to a next cluster and removed from the first cluster or the cluster defined in the previous iteration of operation 240. For example, the time series number from the indexes saved in association with D(k,j) may be saved in association with the iteration number to assign the time series excluding each time series associated with TS₍ᵢ₎: G_{k,i}<CBₖ, i=1, . . . , nᵣ to the next cluster. The selected time series and each time series associated with TS₍ᵢ₎: G_{k,i}<CBₖ, i=1, . . . , nᵣ remain assigned to the first cluster or the cluster defined in the previous iteration of operation 240. A break location, CBₖ, defines a location at which the first cluster, or the cluster defined in the previous iteration of operation 240, is split to form the next cluster. For example, referring again to FIG. 4, when the indicated break test is “maximum test”, the gap width value, G_{k,i}, associated with G_{k,4} is a maximum gap width value so the break location occurs between TS₄ and TS₅ resulting in time series TS₍ᵢ₎, i=1, 2, 3, 4 being included with the first time series in the first cluster, and TS₍ᵢ₎, i=5, 6, 7, 8, 9 being removed from the first cluster and included in the next cluster.

In an operation 242, a next time series is selected. For example, the next time series may be defined as the time series associated with Dₖ₍ₙ_{ᵣ}₎, which is the time series having the largest distance from the selected time series.

In an operation 244, a next remaining set of time series is identified. The next remaining set of time series are those time series assigned to the next cluster except for the next time series selected in operation 242.

Processing continues in operation 224 to process a next iteration to test for uniformity using the selected next time series as the selected time series and the identified next remaining set of time series as the remaining set of time series. The iteration number indicates the number of clusters created and output in operation 234.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” in the detailed description is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated.

What is claimed is:

1. A non-transitory computer-readable medium having stored thereon computer-readable instructions that when executed by a computing device cause the computing device to:
receive time series data, wherein the time series data includes a plurality of time series, wherein a plurality of time points are defined in association with each of the plurality of time series;
compute values of a distance between a first time series of the plurality of time series and each of a remaining set of time series of the plurality of time series, wherein values of the distance are computed pairwise between each of the remaining set of time series of the plurality of time series and the first time series;
sort the computed values of the distance in increasing value;
compute gap width values as a difference between successive pairs of the sorted, computed values;
determine whether a cluster including the received time series data is uniform based on the computed gap width values; and
output cluster data that includes the first time series and the remaining set of time series assigned to the cluster when the cluster is determined to be uniform.

2. The non-transitory computer-readable medium of claim 1, wherein determining whether a cluster is uniform comprises computer-readable instructions that further cause the computing device to:
compute a uniformity measure using the computed gap width values;
compute a uniformity criterion using the computed gap width values; and
compare the computed uniformity measure to the computed uniformity criterion to determine whether the cluster is uniform.

3. The non-transitory computer-readable medium of claim 2, wherein the cluster is determined to be uniform when the computed uniformity measure is greater than or equal to the computed uniformity criterion.

4. The non-transitory computer-readable medium of claim 2, wherein the uniformity criterion is computed as a statistic of the computed gap width values, wherein the statistic is selected from the group consisting of a maximum, a minimum, a mean, and a median of the computed gap width values.

5. The non-transitory computer-readable medium of claim 2, wherein computing the uniformity criterion comprises computer-readable instructions that further cause the computing device to sort the computed gap width values in order of decreasing value and to select a defined number of candidates of the sorted, computed gap width values to include when computing the uniformity criterion.

6. The non-transitory computer-readable medium of claim 5, wherein computing the uniformity criterion further comprises computer-readable instructions that further cause the computing device to compute a statistic using the selected, defined number of candidates of the sorted, computed gap width values.

7. The non-transitory computer-readable medium of claim 6, wherein the statistic is selected from the group consisting of a maximum, a minimum, a mean, and a median.

8. The non-transitory computer-readable medium of claim 2, wherein computing the uniformity measure comprises computer-readable instructions that further cause the computing device to compute a mean of the computed gap width values and to compute a standard deviation of the computed gap width values, wherein the uniformity measure is computed using U_{Gk}= G̅ₖ+c*se(Gₖ), where c is a confidence parameter value, G̅ₖ is the computed mean, and se(Gₖ) is the computed standard deviation.

9. The non-transitory computer-readable medium of claim 2, wherein computing the uniformity criterion comprises computer-readable instructions that further cause the computing device to compute a test statistic value using a test statistic computation method.

10. The non-transitory computer-readable medium of claim 9, wherein computing the uniformity criterion further comprises computer-readable instructions that further cause the computing device to compute a p-value based on the test statistic value, wherein the p-value is a probability of obtaining a test statistic result at least as extreme as the test statistic value, assuming that a null hypothesis is true.

11. The non-transitory computer-readable medium of claim 9, wherein the uniformity criterion is a value of a significance level.

12. The non-transitory computer-readable medium of claim 1, wherein, when the cluster is determined to not be uniform, the computer-readable instructions further cause the computing device to:
compute a break location using the computed gap width values;
assign time series associated with computed values of the distance greater than the distance associated with the computed break location to a next cluster;
select a next time series from the time series associated with computed values of the distance greater than the distance associated with the computed break location;
identify a next remaining set of time series from the time series associated with computed values of the distance greater than the distance associated with the computed break location excluding the selected next time series;
compute second values of a second distance between the selected next time series and each of the identified next remaining set of time series, wherein second values of the second distance are computed between each of the identified next remaining set of time series and the selected next time series;
sort the computed second values of the second distance in increasing value;
compute second gap width values as a second difference between successive pairs of the sorted, computed second values;
determine if the next cluster is uniform based on the computed second gap width values; and
output cluster data that includes the selected next time series and the identified next remaining set of time series assigned to the next cluster when the next cluster is determined to be uniform.

13. The non-transitory computer-readable medium of claim 12, wherein computing the break location comprises computer-readable instructions that further cause the computing device to sort the computed gap width values in order of decreasing value and to select a defined number of candidates of the sorted, computed gap width values to include when computing the break location.

14. The non-transitory computer-readable medium of claim 13, wherein computing the break location further comprises computer-readable instructions that further cause the computing device to compute a statistic using the selected, defined number of candidates of the sorted, computed gap width values.

15. The non-transitory computer-readable medium of claim 14, wherein the statistic is selected from the group consisting of a maximum, a minimum, a mean, and a median.

16. The non-transitory computer-readable medium of claim 12, wherein the break location is computed as a statistic of the computed gap width values, wherein the statistic is selected from the group consisting of a maximum, a minimum, a mean, and a median.

17. The non-transitory computer-readable medium of claim 12, wherein the break location is computed using a sequential local uniformity test of the computed gap width values.

18. The non-transitory computer-readable medium of claim 12, wherein the next time series is selected as a time series associated with a maximum value of the computed values of the distance.

19. The non-transitory computer-readable medium of claim 12, wherein the computer-readable instructions further cause the computing device to output second cluster data that includes the first time series and any time series associated with computed values of the distance less than the distance associated with the computed break location to a first cluster.

20. The non-transitory computer-readable medium of claim 1, wherein the values of the distance are computed using a dynamic time warping distance computation method or a Euclidian distance computation method.

21. A computing device comprising:
a processor; and
a non-transitory computer-readable medium operably coupled to the processor, the computer-readable medium having computer-readable instructions stored thereon that, when executed by the processor, cause the computing device to
receive time series data, wherein the time series data includes a plurality of time series, wherein a plurality of time points are defined in association with each of the plurality of time series;
compute values of a distance between a first time series of the plurality of time series and each of a remaining set of time series of the plurality of time series, wherein values of the distance are computed pairwise between each of the remaining set of time series of the plurality of time series and the first time series;
sort the computed values of the distance in increasing value;
compute gap width values as a difference between successive pairs of the sorted, computed values;
determine whether a cluster including the received time series data is uniform based on the computed gap width values; and
output cluster data that includes the first time series and the remaining set of time series assigned to the cluster when the cluster is determined to be uniform.

22. The computing device of claim 21, wherein determining whether a cluster is uniform comprises computer-readable instructions that further cause the computing device to:
compute a uniformity measure using the computed gap width values;
compute a uniformity criterion using the computed gap width values; and
compare the computed uniformity measure to the computed uniformity criterion to determine whether the cluster is uniform.

23. The computing device of claim 22, wherein the uniformity criterion is computed as a statistic of the computed gap width values, wherein the statistic is selected from the group consisting of a maximum, a minimum, a mean, and a median of the computed gap width values.

24. The computing device of claim 22, wherein computing the uniformity measure comprises computer-readable instructions that further cause the computing device to compute a mean of the computed gap width values and to compute a standard deviation of the computed gap width values, wherein the uniformity measure is computed using U_{Gk}= G̅ₖ+c*se(Gₖ), where c is a confidence parameter value, G̅ₖ is the computed mean, and se(Gₖ) is the computed standard deviation.

25. The computing device of claim 22, wherein computing the uniformity criterion comprises computer-readable instructions that further cause the computing device to compute a test statistic value using a test statistic computation method.

26. The computing device of claim 21, wherein, when the cluster is determined to not be uniform, the computer-readable instructions further cause the computing device to:
compute a break location using the computed gap width values;
assign time series associated with computed values of the distance greater than the distance associated with the computed break location to a next cluster;
select a next time series from the time series associated with computed values of the distance greater than the distance associated with the computed break location;
identify a next remaining set of time series from the time series associated with computed values of the distance greater than the distance associated with the computed break location excluding the selected next time series;
compute second values of a second distance between the selected next time series and each of the identified next remaining set of time series, wherein second values of the second distance are computed between each of the identified next remaining set of time series and the selected next time series;
sort the computed second values of the second distance in increasing value;
compute second gap width values as a second difference between successive pairs of the sorted, computed second values;
determine if the next cluster is uniform based on the computed second gap width values; and
output cluster data that includes the selected next time series and the identified next remaining set of time series assigned to the next cluster when the next cluster is determined to be uniform.

27. A method of transforming time series data to cluster data, the method comprising:
receiving time series data, wherein the time series data includes a plurality of time series, wherein a plurality of time points are defined in association with each of the plurality of time series;
computing, by a computing device, values of a distance between a first time series of the plurality of time series and each of a remaining set of time series of the plurality of time series, wherein values of the distance are computed pairwise between each of the remaining set of time series of the plurality of time series and the first time series;
sorting, by the computing device, the computed values of the distance in increasing value;
computing, by the computing device, gap width values as a difference between successive pairs of the sorted, computed values;
determining, by the computing device, whether a cluster including the received time series data is uniform based on the computed gap width values; and
outputting, by the computing device, cluster data that includes the first time series and the remaining set of time series assigned to the cluster when the cluster is determined to be uniform.

28. The method of claim 27, further comprising:
computing, by the computing device, a uniformity measure using the computed gap width values;
computing, by the computing device, a uniformity criterion using the computed gap width values; and
comparing, by the computing device, the computed uniformity measure to the computed uniformity criterion to determine whether the cluster is uniform.

29. The method of claim 28, wherein the uniformity criterion is computed as a statistic of the computed gap width values, wherein the statistic is selected from the group consisting of a maximum, a minimum, a mean, and a median of the computed gap width values.

30. The method of claim 28, wherein computing the uniformity measure comprises computing a mean of the computed gap width values and computing a standard deviation of the computed gap width values, wherein the uniformity measure is computed using U_{Gk}= G̅ₖ+c*se(Gₖ), where c is a confidence parameter value, G̅ₖ is the computed mean, and se(Gₖ) is the computed standard deviation.

31. The method of claim 28, wherein the uniformity criterion comprises computing a test statistic value using a test statistic computation method.

32. The method of claim 27, further comprising, when the cluster is determined to not be uniform:
computing, by the computing device, a break location using the computed gap width values;
assigning, by the computing device, time series associated with computed values of the distance greater than the distance associated with the computed break location to a next cluster;
selecting, by the computing device, a next time series from the time series associated with computed values of the distance greater than the distance associated with the computed break location;
identifying, by the computing device, a next remaining set of time series from the time series associated with computed values of the distance greater than the distance associated with the computed break location excluding the selected next time series;
computing, by the computing device, second values of a second distance between the selected next time series and each of the identified next remaining set of time series, wherein second values of the second distance are computed between each of the identified next remaining set of time series and the selected next time series;
sorting, by the computing device, the computed second values of the second distance in increasing value;
computing, by the computing device, second gap width values as a second difference between successive pairs of the sorted, computed second values;
determining, by the computing device, if the next cluster is uniform based on the computed second gap width values; and
outputting, by the computing device, cluster data that includes the selected next time series and the identified next remaining set of time series assigned to the next cluster when the next cluster is determined to be uniform.
